(19) United States
(12) Patent Application Publication
(10) Pub. No.: US 2024/0049737 A1
(43) Pub. Date: Feb. 15, 2024

(54) CREAMER

(71) Applicant: SOCIETE DES PRODUITS NESTLE S.A., Vevey (CH)

(72) Inventors: VIRGINIE DE BOISHEBERT, Munsingen (CH); JAMES ROBSON, Konolfingen (CH); KORINA TERRAZAS, Konolfingen (CH)

(21) Appl. No.: 18/257,788

(22) PCT Filed: Dec. 7, 2021
(86) PCT No.: PCT/EP2021/084480

§ 371 Date: Jun. 15, 2023

(30) Foreign Application Priority Data
Dec. 18, 2020 (EP) 20215284.9

(51) Int. Cl. A23C 11/10; B65D 85/804

(52) U.S. Cl. CPC A23C 11/10; B65D 85/804

(57) ABSTRACT

A creamer composition comprising sugar beet pectin, vegetable oil and bulking agent, a beverage capsule comprising such creamer, a beverage system comprising such creamer, a beverage composition comprising such creamer and a method of producing such creamer. Furthermore, the use of sugar beet pectin as an emulsifier in a creamer composition.

### FIELD OF THE INVENTION

The present invention relates to a creamer composition comprising sugar beet pectin, vegetable oil and a bulking agent. The present invention relates to the use of sugar beet pectin as the sole or primary oil in water emulsifier in a creamer composition.

### BACKGROUND TO THE INVENTION

Creamers are widely used as whitening agents and texture/mouthfeel modifiers for hot and cold beverages, e.g., coffee, cocoa, tea, etc. They are commonly used as an alternative to milk or dairy cream. Creamers may come in a variety of different flavours and provide a whitening effect, mouthfeel, body, and a smoother texture, and may be in powdered or liquid form.

The creamer needs to be physically stable when added to foods and drinks made with water. For a creamer to perform well in a beverage, the creamer should be stable and free of aggregates or clumps when added to the beverage and until the beverage is completely consumed.

There is a growing demand for vegan and plant-based alternatives in the food industry. However, the majority of vegan creamers on the market rely upon the use of expensive plant proteins or and/or non-clean label emulsifiers to retain stability.

Plant proteins (e.g. pea, potato, rice) often impart strong legume flavours, which require masking. A further problem with vegetable proteins is that they are generally required to undergo a hydrolysis stage in order to increase the solubility, which can lead to an unstable emulsion. Hydrolysis of plant proteins is also often associated with a “used vegetable water” flavour. Furthermore, possibly the highest functional plant protein is from soy, but soy proteins are often of GMO origin, soy is a major allergen and acceptability of the soy flavour is currently limited. Further solutions are commonly based on coconut or almond milk, which are not particularly versatile for sensorial profiles.

Other dairy-free creamers rely on the use of non-clean emulsifiers and/or e-numbers, which are generally undesired based on consumer perception.

Thus, there is a demand for clean label vegan creamer compositions.

### SUMMARY OF THE INVENTION

The present inventors have surprisingly found that sugar beet pectin gives excellent emulsifying properties when used as a sole emulsifier for oil in water emulsions.

Currently, plant proteins fail to achieve target fat droplet size, which may consequently make thorough fat encapsulation a challenge during the drying process. The present inventors have surprisingly found that the sugar beet pectin emulsions consisted of a median particle size of <1 micron, which could be spray dried with ease to form a powder with satisfactory rehydration properties, whilst retaining an excellent emulsion.

The present inventors have surprisingly found that no co-emulsifier is necessary and that the sugar beet pectin emulsions are stable across a range of pH.

According to one aspect of the present invention there is provided a creamer composition comprising pectin, preferably sugar beet pectin, an oil component, preferably vegetable oil, and a bulking agent.

In some embodiments, the composition is in the form of a powdered creamer or a liquid creamer, preferably a powdered creamer.

The pectin may be a high ester pectin, optionally wherein the pectin has a degree of esterification (DE) of at least about 50%, or at least about 55%, or from about 50% to about 60%, or about 55%.

The pectin may have a degree of acetylation (DAc) of at least about 10%, or at least about 15%, or at least about 20%, optionally wherein the pectin has a DAc of from about 10% to about 30%, or from about 14% to about 26%, or from about 20% to about 25%.

The creamer composition may comprise the pectin in an amount of from about 0.1 wt % to about 2.5 wt %, from about 0.3 wt % to about 1.5 wt %, or from about 0.7 wt % to about 1 wt.

In some embodiments, the pectin and the oil are present in a pectin:oil weight ratio of from about 1:500 to about 1:4, or from about 1:250 to about 1:10, or from about 1:100 to about 1:20, or from about 1:25 to about 1:20.

In some embodiments, the pH of the creamer composition is at least about pH 3, at least about pH 4, at least about pH 5, at least about pH 6, or at least about pH 6.5, or from about pH 6.5 to about pH 8

In some embodiments, the creamer composition further comprises a base.

In some embodiments, the base comprises or consists of one or more of: a carbonate salt, a bicarbonate salt (a hydrogen carbonate salt), or a hydroxide salt, or a solution thereof.

In some embodiments, the base comprises or consists of one or more of: calcium carbonate, magnesium carbonate, potassium carbonate, sodium carbonate, magnesium hydroxide carbonate, potassium hydrogen carbonate, sodium hydrogen carbonate, sodium sesquicarbonate, calcium hydroxide, magnesium hydroxide, potassium hydroxide, and sodium hydroxide, or a solution thereof.

In some embodiments, the base comprises of consists of sodium hydrogen carbonate or calcium carbonate, or a solution thereof.

The creamer composition may comprise the oil in an amount of from about 10 wt % to about 50 wt %, from about 25 wt % to about 50 wt %, or from about 35 wt % to about 50 wt %.

In some embodiments, the oil comprises or consists of one or more of: coconut oil, soy bean oil, rapeseed oil, sunflower oil, canola oil, safflower oil, palm oil, palm kernel oil, algal oil, cotton seed oil, or corn oil, and olive oil.

In some embodiments, the oil comprises or consists of non-hydrogenated vegetable oil, hydrogenated vegetable oil, interesterified vegetable oil, and/or medium-chain triglyceride (MCT) vegetable oil.

In some embodiments, the oil comprises or consists of coconut oil, hydrogenated coconut oil and/or MCT oil, preferably wherein the MCT oil is derived from coconut and/or palm kernel oil.

The creamer composition may comprises the bulking agent in an amount of from about 10 wt % to about 80 wt %.

In some embodiments, the bulking agent comprises or consists of one or more of: syrups; soluble/insoluble fibers, preferably derived from corn, wheat, pea, rice, oat, coconut, barley and/or tapioca; fructo- and galacto-oligosaccharides; and hydrolysed cereal flour

In some embodiments, the bulking agent comprises or consists of one or more of: glucose syrup, powdered glucose, starch, corn syrup solids, maltodextrin, and dextrin. In some embodiments, the bulking agent comprises or consists of glucose syrup.

In some embodiments, the creamer composition comprises: the pectin in an amount of from about 0.1 wt % to about 2.5 wt %; the oil in an amount of from about 10 wt % to about 50 wt %; and the bulking agent in an amount of from about 10 wt % to about 80 wt %.

In some embodiments, the creamer composition is a foaming creamer.

In some embodiments, the creamer composition further comprises a foaming aid.

In some embodiments, the foaming aid comprises of consists of one or more of: plant protein, optionally wherein the plant protein is selected from one or more of faba bean protein, pea protein, rice protein, oat protein, soy protein; polysaccharide; and saponin, optionally wherein the saponin is derived from quillaja.

In some embodiments, the creamer composition is substantially devoid of buffering agent and/or stabilising agent.

In some embodiments, the only emulsifier in the creamer composition is the pectin.

In some embodiments, the creamer composition is a vegan creamer.

In some embodiments, the creamer composition is a beverage creamer, preferably a coffee creamer, a tea creamer or a cocoa creamer. Preferably, the creamer composition is a coffee creamer.

According to another aspect of the present invention, there is provided a beverage capsule comprising the creamer composition of the invention.

According to another aspect of the present invention, there is provided a beverage system comprising the creamer composition of the invention.

According to another aspect of the present invention, there is provided a beverage composition comprising the creamer composition of the invention, optionally wherein the beverage composition is a coffee, tea, or cocoa beverage.

In some embodiments, the beverage composition is a ready-to-drink beverage or a ready-to-use beverage.

According to another aspect of the present invention, there is provided use of pectin, preferably sugar beet pectin, as an emulsifier in a creamer composition, preferably a beverage creamer composition, such as a coffee creamer, a tea creamer or a cocoa creamer.

According to another aspect of the present invention, there is provided a method for producing a creamer composition (e.g. a creamer composition of the present invention), comprising:
(i) providing: an aqueous phase comprising pectin, preferably sugar beet pectin; an oil phase comprising an oil component, preferably vegetable oil; and a bulking agent;
(ii) mixing the aqueous phase, the oil phase, and the bulking agent to form a pre-emulsion;
(iii) homogenising the pre-emulsion to form an emulsion concentrate;
(iv) optionally drying the emulsion concentrate to form a powdered creamer composition.

In some embodiments, the aqueous phase and oil phase are mixed prior to the adding the buking agent.

In some embodiments, the method further comprises a heat treatment step.

In some embodiments, the method further comprises a foaming step.

In some embodiments, the method further comprises a step of cooling the creamer composition and/or a further step of packing the creamer composition.

In some embodiments, the drying is spray drying.

According to another aspect of the present invention, there is provided a method of preparing a beverage composition, comprising:
(i) providing a beverage composition base; and
(ii) adding the creamer composition of the invention to the beverage composition base.

### DESCRIPTION OF DRAWINGS

FIG. 1—Stability of sugar beet pectin emulsified creamers

(A) Concentrate after homogenisation (left) and diluted for PSD measurements (right).

(B) Concentrate added to coffee to assess stability

FIG. 2—PSD of sugar beet pectin emulsified creamers

PSD of pectin based emulsion compared to the rice protein-lecithin reference. The pectin based emulsion has a d(4,3) of ˜1.3 um compared to 9.6 um for the protein-lecithin reference.

FIG. 3—Rheology of sugar beet pectin emulsified creamers

(A) Rheology of pectin-based creamer up to shear rate of 600 s⁻¹ at 75° C.

(B) Rheology of rice protein-lecithin reference up to shear rate of 600 s⁻¹ at 75° C.

FIG. 4—PSD of emulsion concentrate from trials 29805.070 and 29805.075

(A) PSD of emulsion concentrate from trials 29805.070

(B) PSD of emulsion concentrate from trials 29805.075

FIG. 5—Reconstituted trial 29805.075 compared to rice protein-lecithin reference creamer

FIG. 6—PSD of emulsion concentrate from trials 32069.014 and 32069.015

(A) PSD of emulsion concentrate from trials 32069.014

(B) PSD of emulsion concentrate from trials 32069.015

FIG. 7—Reconstituted trials 32069.014 and 32069.015 Samples were reconstituted as follows—9 g creamer, 1.7 g coffee, 200 ml water (85° C.).

FIG. 8—PSD of emulsion concentrate from trial 35761.011

FIG. 9—Preparation of sugar beet pectin based coffee creamer and preparation of hydrolysed rice protein based coffee creamer

(A) Process flow chart for Trial 37964.005 (sugar beet pectin).

(b) Process flow chart for Trial 37964.006 (hydrolysed rice protein).

FIG. 10—PSD of emulsion concentrate from trials 37964.005 and 37964.006

Fat globule size distribution in concentrate for (A) sugar beet pectin trial, (B) hydrolysed rice protein trial showing emulsion quality is much better (much smaller sizes) for sugar beet pectin trial at comparable homogenization conditions (180/50 bar) and fat content (35%).

FIG. 11—PSD of reconstituted powder from Examples 4-3 and 4-4

(A) PSD of reconstituted powder from Example 4-3

(B) PSD of reconstituted powder from Example 4-4

FIG. 12—PSD of liquid creamers from Examples 4-7 and 4-11

(A) PSD of reconstituted powder from Example 4-7

(B) PSD of reconstituted powder from Example 4-8

(C) PSD of reconstituted powder from Example 4-6

(D) PSD of reconstituted powder from Example 4-9

(E) PSD of reconstituted powder from Example 4-10

(F) PSD of reconstituted powder from Example 4-11

FIG. 13—Foam overrun in pectin stabilized emulsions with added plant proteins

Foam overrun was measured after foaming in a Nespresso Cappuccinatore.

FIG. 14—Schematic of a pectin chain showing esterification and acetylation

### DETAILED DESCRIPTION

Various preferred features and embodiments of the present invention will now be described. The skilled person will understand that they can combine all features of the invention disclosed herein without departing from the scope of the invention as disclosed.

It must be noted that as used herein and in the appended claims, the singular forms “a”, “an”, and “the” include plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” also include the term “consisting of”.

Unless otherwise specified, numeric ranges are inclusive of the numbers defining the range.

The publications discussed herein are provided solely for their disclosure prior to the filing date of the present application. Nothing herein is to be construed as an admission that such publications constitute prior art to the claims appended hereto.

Creamer Composition

According to one aspect of the present invention, there is provided a creamer composition.

By a “creamer composition” is meant a composition that is intended to be added to a beverage or food composition, such as e.g. coffee, tea, cocoa or soup, to impart specific characteristics such as colour (e.g. whitening effect), thickening, flavour, texture, and/or other desired characteristics. A creamer composition may be intended to substitute for milk or cream in such beverages of food compositions.

A creamer composition of the invention may be in powdered or liquid form, preferably a powdered form. Suitably, a liquid creamer composition may comprise water in an amount of about 5 wt % to about 50 wt %, or about 10 wt % to about 40 wt %, or about 20 wt % to about 30 wt %. Suitably, a powdered creamer composition may comprise water in an amount of about 5 wt % or less, or about 3 wt % or less.

Preferably, the creamer composition is non-dairy. A “non-dairy creamer composition” may be a creamer composition containing no substances derived from dairy products (e.g. casein).

Preferably, the creamer composition is vegan. A “vegan creamer composition” may be a creamer composition containing no substances derived from animals (including e.g. substances derived from eggs or dairy products).

In preferred embodiments, the creamer composition is a beverage creamer. A “beverage creamer” may be a creamer composition which is intended to substitute for milk or cream in coffee, tea, cocoa or other beverages. Suitably, the creamer composition is a coffee creamer, a tea creamer and/or a cocoa creamer. Preferably, the creamer composition is a coffee creamer.

Pectin

The creamer composition of the present invention comprises pectin, preferably the creamer composition of the present invention comprises sugar beet pectin.

The creamer composition may comprise the pectin in any suitable amount. In some embodiments, the creamer composition comprises pectin in an amount of at least about 0.1 wt %, at least about 0.2 wt %, at least about 0.3 wt %, at least about 0.5 wt %, or at least about 0.7 wt %.

In some embodiments, the creamer composition comprises pectin in an amount of from about 0.1 wt % to about 2.5 wt %, from about 0.3 wt % to about 1.5 wt %, or from about 0.7 wt % to about 1 wt %.

Pectins, also known as pectic polysaccharides, are rich in galacturonic acid. Pectins can include homogalacturonan, rhamnogalacturonan-I, and rhamnogalacturonan-II structural elements. Homogalacturonan is the most abundant pectin and is a homopolymer of up to 200 units of α(1-4)-linked D-galacturonic acid. Rhamnogalacturonan-I pectins contain a backbone of the repeating disaccharide: 4)-α-D-galacturonic acid-(1,2)-α-L-rhamnose-(1. Rhamnogalacturonan-II is a less frequent, complex, highly branched polysaccharide.

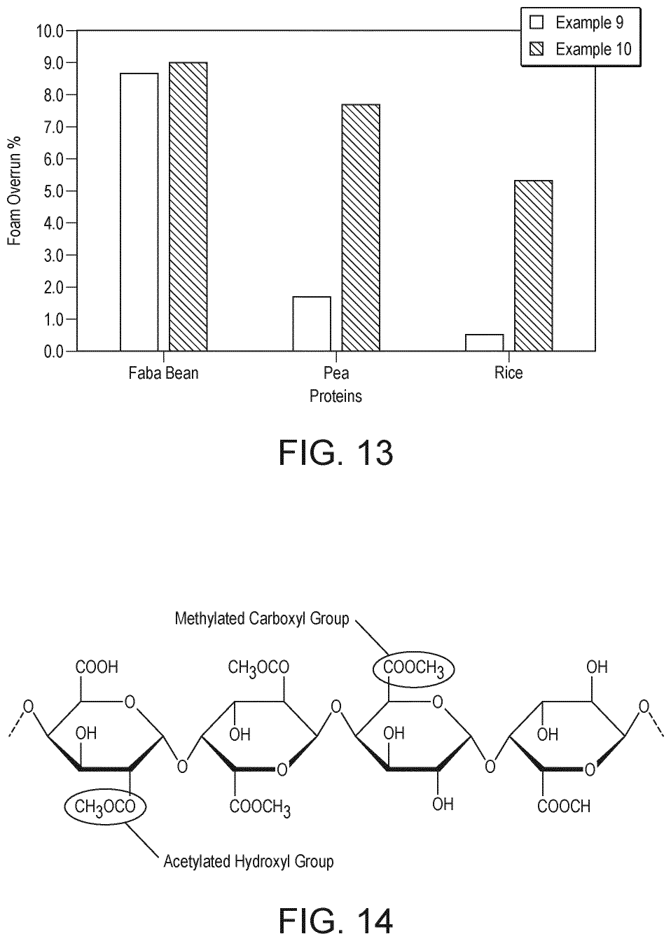

The C6 carboxyl groups of galacturonic acid may be esterified with methanol, as shown in FIG. 14. The degree of esterification (DE) is the percentage of galacturonic acid which is esterified with methanol and has a maximum value of 100% % (since each galacturonic acid can be esterified once).

The O2 and/or O3 hydroxyl groups of the galacturonic acid may be acetylated, as shown in FIG. 14. The degree of acetylation (DAc) is the percentage of galacturonic acid which is acetylated and can have a value of >100% (since each galacturonic acid can be acetylated more than once).

The degree of esterification and the degree of acetylation can be determined by any method known to the skilled person. For example, the degree of esterification and the degree of acetylation can be determined using the following formula:

Degree of esterification=(millimoles methanol/millimoles uronic acid)×100

Degree of acetylation=(millimoles acetic acid/millimoles uronic acid)×100

where the content of uronic acid is determined using a colorimetric procedure and the methanol and acetic acid content is determined by HPLC following alkali treatment of the pectin sample. For example, as described in Melton, L. D. and Smith, B. G., 2001. Current Protocols in Food Analytical Chemistry, (1), E3-3 and E3-4.

The amount, structure and chemical composition of pectin differs among plants, within a plant over time, and in various parts of a plant. For example, the degree of esterification can range from about 10% or lower to about 80% or higher and the degree of acetylation can vary from about 2% or lower to about 20% or higher.

Pectins with a low DE (<50%) may form a gel through hydrogen bonding and hydrophobic interactions in acidic conditions and in the presence of sugars. This generally requires a solid content of >60%. Pectins with a high DE (>50%) gelate in the presence of divalent cations such as Ca2+. This may occur in much lower total solid content (10-70%).

The pectin used in the present invention may be a high DE pectin. Suitably, the pectin has a degree of esterification (DE) of at least about 50%, or at least about 55%, or from about 50% to about 60%, or about 55%.

Pectins with a high DAc (e.g. >10%) may have a reduced gelling capacity but may improve emulsifying ability. The hydrophobic nature of the acetylated groups can coat the oil interface and reduce interfacial tension, whilst the carbohydrate chain increases viscosity and stabilises the emulsion. Hydration of latter chains are believed to contribute by forming a hydrated layer to increase steric stabilization.

The pectin used in the present invention may be a high DAc pectin. Suitably, the pectin has a degree of acetylation (DAc) of at least about 10%, or at least about 15%, or at least about 20%. Suitably, the pectin has a degree of acetylation (DAc) of about 10% to about 30%, or from about 14% to about 26%, or from about 20% to about 25%.

The pectin used in the present invention may be a high DE and a high DAc pectin. For example, the pectin suitably has a degree of esterification (DE) of at least about 50% and a degree of acetylation (DAc) of at least about 10%.

Suitably, the pectin has a molecular weight of at least about 30,000 Da, at least about 40,000 Da, at least about 50,000 Da, or at least about 60,000 Da.

Suitably, the pectin has a viscosity in a 2 wt % solution of from about 10 cps to about 150 cps.

Sugar Beet Pectin

In some embodiments, the pectin used in the present invention comprises or consists of sugar beet pectin. In preferred embodiments, the pectin used in the present invention is sugar beet pectin.

Sugar beet pectin can be extracted from sugar beet pulp by any method known to the skilled person. For example, as described by Thibault et al., 1985. Journal of Food Science, 50(5), pp. 1499-1500. Any commercial source of sugar beet pectin may be used.

Sugar beet pectin is rarely used as a texturizer due to the poor gelling ability compared to apple and citrus pectin. The reduced gelling capacity is attributed to acetylation of the galacturonic acid. This is rare in natural pectins but is desired for the improvement of emulsifying properties.

In addition, sugar beet pectin may have a relatively high protein content compared to other pectins, which may influence the emulsifying ability. This increases the capacity to activate the oil-water interface adsorbing favourably on to the surface of oil droplets.

The sugar beet pectin may have a degree of esterification (DE) of at least about 50%, or at least about 55%, or from about 50% to about 60%, or about 55%. The sugar beet pectin may have a degree of acetylation (DAc) of about 10% to about 30%, or from about 14% to about 26%, or from about 20% to about 25%.

Other Pectins

Other pectins may be used which have the same properties (e.g. DE and DAc) as sugar beet pectin.

For example, modified pectin may be used. Pectins with a low DE and/or low DAc may be esterified and/or acetylated using any method known to the skilled person to arrive at a pectin with similar properties to sugar beet pectin. For example, using the methods described in Renard, C. M. G. C. and Jarvis, M. C., 1999. Carbohydrate Polymers, 39(3), pp. 201-207.

In some embodiments, the creamer composition does not comprise any pectin other than sugar beet pectin.

The present invention provides for use of pectin (e.g. sugar beet pectin) as an emulsifier in a creamer composition, preferably a beverage creamer composition, such as a coffee creamer, a tea creamer or a cocoa creamer.

Oil Component

In addition to pectin, the creamer composition of the present invention comprises an oil component, preferably vegetable oil.

The creamer composition may comprise the oil component in any suitable amount. In some embodiments, the pectin and the oil component are present in a pectin:oil weight ratio of at least about 1:500, at least about 1:250, at least about 1:200, at least about 1:100, at least about 1:50, or at least about 1:25. In some embodiments, the pectin and the oil component are present in a pectin:oil weight ratio of from about 1:500 to about 1:4, or from about 1:250 to about 1:10, or from about 1:100 to about 1:20, or from about 1:25 to about 1:20.

In some embodiments, the creamer composition comprises the oil component in an amount of at least about 10 wt %, at least about 15 wt %, at least about 20 wt %, at least about 25 wt %, at least about 30 wt %, or at least about 35 wt %. In some embodiments, the creamer composition comprises the oil component in an amount of from about 10 wt % to about 50 wt %, from about 15 wt % to about 50 wt %, from about 20 wt % to about 50 wt %, from about 25 wt % to about 50 wt %, or from about 35 wt % to about 50 wt %.

Any oil which is suitable for a creamer may be used as the oil component. Preferably, the oil component is vegetable oil, for example oil extracted from seeds or other parts of fruits or vegetables. Suitably, the oil component comprises or consists of one or more of: coconut oil, soy bean oil, rapeseed oil, sunflower oil, canola oil, safflower oil, palm oil, palm kernel oil, algal oil, cotton seed oil, or corn oil, and olive oil. In some embodiments, the oil component comprises or consists of coconut oil

The oil component may be a processed oil, e.g. hydrogenated, interesterified, and/or fractionated oil. For example, the oil component may comprise or consist of non-hydrogenated vegetable oil, hydrogenated vegetable oil, interesterified vegetable oil and/or medium-chain triglyceride (MCT) vegetable oil.

“Hydrogenated oils” are oils in which some of the unsaturated fatty acids have been converted to saturated fatty acids by hydrogenation. Exemplary hydrogenated oils include hydrogenated coconut oil, hydrogenated palm oil, hydrogenated palm kernel oil, and the like. “Non-hydrogenated oils” are oils which have not undergone hydrogenation. Exemplary hydrogenated oils include non-hydrogenated coconut oil, and the like.

“Interesterified oils” are oils which have undergone interesterification, a chemical or enzymatic process in which the ester bonds that connect the fatty acid chains to the glycerol are broken and reformed to provide a mixture of fatty acids. Exemplary interesterified oils include interesterified palm oil, and the like.

“MCT oils” are oils which are composed of saturated triglycerides comprising C4-C14, but preferably C8-C12 saturated fatty acid chains. MCT oil can be isolated by fractionation, for example from coconut oil and/or palm kernel oil. In some embodiments, the oil comprises MCT oil.

In some embodiments, the oil component comprises or consists of coconut oil (e.g. hydrogenated and/or non-hydrogenated coconut oil) and/or MCT oil.

Bulking Agent

In addition to pectin and the oil component, the creamer composition of the present invention comprises a bulking agent.

The creamer composition may comprise the bulking agent in any suitable amount. The creamer composition may comprise the bulking agent in an amount of from about 10 wt % to about 80 wt %. For example, the creamer composition may comprise: the pectin in an amount of from about 0.1 wt % to about 2.5 wt %; the oil in an amount of from about 10 wt % to about 50 wt %; and the bulking agent in an amount of from about 10 wt % to about 80 wt %.

Bulking agents are additives that increase the bulk (volume or weight) of a composition without significantly affecting its taste and whilst keeping its utility and functionality intact.

Any suitable bulking agent may be used and are well known in the art. Suitably, the bulking agent comprises or consists of one or more of: syrups; soluble/insoluble fibers, preferably derived from corn, wheat, pea, rice, oat, coconut, barley and/or tapioca; fructo- and galacto-oligosaccharides; and hydrolysed cereal flour.

In some embodiments, the bulking agent comprises or consists of one or more of: glucose syrup, powdered glucose, starch, corn syrup solids, maltodextrin, and dextrin.

In some embodiments, the bulking agent comprises or consists of glucose syrup.

pH Control Agent

The pH of the creamer composition may be at least about pH 3, at least about pH 4, at least about pH 5, at least about pH 6, or at least about pH 6.5, or from about pH 6.5 to about pH 8.

The pH of sugar beet pectin is typically low and adjusting the pH of the creamer composition (e.g. to at least about pH 5) can give less astringency and greater mouth coating once reconstituted.

In some embodiments, the pH of the creamer composition is at least about pH 5, at least about pH 6, or at least about pH 6.5, or from about pH 6.5 to about pH 8.

The pH of the creamer composition can be controlled by any method known to the skilled person. For example, the creamer composition may comprise one or more pH control agent.

The creamer composition may comprise the one or more pH control agent in any suitable amount. Suitably, the creamer composition may comprise the one or more pH control agent in an amount of at least about 0.01 wt %, or at least about 0.1 wt %. Suitably, the creamer composition may comprise the one or more pH control agent in an amount of from about 0.01 wt % to about 5 wt %, or from about 0.1 wt % to about 5 wt %

As used herein, a “pH control agent” is an additive used to change or maintain the pH of a composition and includes bases, acids, neutralising agents, and buffering agents. Any suitable pH control agent may be used, for example a base.

In some embodiments, the creamer composition comprises a base. The base may be any suitable organic or inorganic base, or a combination thereof. For example, the base may be a carbonate salt or a solution thereof, a bicarbonate salt (hydrogen carbonate salt) or a solution thereof, or a hydroxide salt or a solution thereof, or a combination thereof.

In some embodiments the creamer composition comprises a base selected from one or more of: calcium carbonate, ammonium carbonate, magnesium carbonate, potassium carbonate, sodium carbonate, ammonium hydrogen carbonate, magnesium hydroxide carbonate, potassium hydrogen carbonate, sodium hydrogen carbonate, sodium sesquicarbonate, ammonium hydroxide, calcium hydroxide, magnesium hydroxide, potassium hydroxide, and sodium hydroxide; or a solution thereof.

In some embodiments the creamer composition comprises a base selected from one or more of: calcium carbonate, magnesium carbonate, potassium carbonate, sodium carbonate, magnesium hydroxide carbonate, potassium hydrogen carbonate, sodium hydrogen carbonate, sodium sesquicarbonate, calcium hydroxide, magnesium hydroxide, potassium hydroxide, and sodium hydroxide; or a solution thereof.

In some embodiments the creamer composition comprises sodium hydrogen carbonate and/or calcium carbonate, or a solution thereof.

In some embodiments, the creamer composition comprises a buffering agent. The buffering agent can prevent undesired creaming or precipitation of the creamer upon addition into a hot, acidic and/or high mineral environment such as coffee. The buffering agent can be, for example, citrate, monophosphates, diphosphates, sodium mono- and bicarbonates, potassium mono- and bicarbonates, or a combination thereof. In some embodiments, the buffering agent is citrate, e.g. created in situ by addition of sodium bicarbonate and citric acid. In some embodiments, buffers are salts such as potassium phosphate or dipotassium phosphate.

In some embodiments, the creamer composition is substantially devoid of buffering agent. In some embodiments, the creamer composition is substantially devoid of added phosphates. By added phosphates are meant phosphates which are added as substantially pure compounds, e.g. to obtain a buffering effect and/or for the purpose of stabilising the creamer composition. The term “added phosphates” is not meant to include phosphates present in minor amounts as natural constituents of other ingredients of the creamer composition.

Foaming Agent

The creamer composition of the invention may be a foaming creamer, i.e. a creamer that produces foam when dissolved in a liquid. Foaming creamers and methods for producing them are well known in the art. A foaming creamer may e.g. be a powdered creamer composition wherein the creamer powder particles are porous and gas is released from the pores upon dissolution to produce foam.

In some embodiments, the creamer composition comprises one or more foaming agent.

The creamer composition may comprise the one or more foaming agent in any suitable amount. Suitably, the creamer composition may comprise the one or more foaming agent in an amount of at least about 0.1 wt %, or at least about 1 wt %. Suitably, the creamer composition may comprise the one or more foaming agent in an amount of from about 0.1 wt % to 10 wt %, or from about 1 wt % to about 10 wt %.

As used herein, a “foaming agent” (also called a “foaming aid”) is an additive that facilitates the formation of foam. For example, foaming agents can include surfactants that reduce surface tension of a liquid or increase colloidal stability by inhibiting coalescence of bubbles. Any suitable foaming agent may be used in any suitable amount.

In some embodiments, the foaming agent comprises of consists of one or more of: plant protein, optionally wherein the plant protein is selected from one or more of faba bean protein, pea protein, rice protein, oat protein, soy protein; polysaccharide; and saponin, optionally wherein the saponin is derived from quillaja.

In some embodiments, the foaming agent comprises of consists of plant protein, optionally wherein the plant protein is selected from one or more of faba bean protein, pea protein, rice protein, oat protein, soy protein. The plant protein may be a plant protein isolate and/or hydrolysed plant protein. In some embodiments, the foaming agent comprises plant protein isolate and/or hydrolysed plant protein.

Other Additional Agents

The creamer composition may comprise any other suitable additional agents. The creamer composition may further include one or more additional agents such as flavourings, sweeteners, colorants, antioxidants, stabilising agents or a combination thereof.

The list of known flavouring agents includes thousands of molecular compounds which are well known in the art. Sweeteners can include, but are not limited to, sugar alcohols such as maltitol, xylitol, sorbitol, erythritol, mannitol, isomalt, lactitol, hydrogenated starch hydrolysates, and the like, alone or in combination. Colorants include any substance that imparts colour to the composition. Usage level of the flavourings, sweeteners, colorants, and antioxidants will vary greatly and will depend on such factors as potency of the sweetener, desired sweetness of the product, level and type of flavouring used and cost considerations.

In some embodiments, the creamer composition is substantially devoid of any added flavourings, sweeteners, colorants, and/or antioxidants.

Stabilising agents can include emulsifiers, thickeners and gelling agents, foam stabilizers, humectants, anticaking agents, and coating agents. For example, stabilising agents can include hydrocolloids which are compounds that help to increase physical viscosity of the composition. Suitable hydrocolloids may be carrageenan, such as kappa-carragenan, iota-carragenan, and/or lambda-carragenan; starch, e.g. modified starch; cellulose, e.g. microcrystalline cellulose, methyl cellulose, or carboxy-methyl cellulose; agar-agar; gelatine; gellan (e.g., high acyl, low acyl); guar gum; gum Arabic; kojac; locust bean gum; pectin; sodium alginate; maltodextrin; tracaganth; xanthan; or a combination thereof.

In some embodiments, the only stabilising agent present in the creamer composition is the pectin. In some embodiments, the only stabilising agents present in the creamer composition are the pectin and the foaming agent (e.g. plant protein).

In some embodiments, the only emulsifier present in the creamer composition is the pectin. In some embodiments, the only emulsifiers present in the creamer composition are the pectin and the foaming agent (e.g. plant protein). Preferably, the creamer composition does not comprise any additional emulsifiers such as low molecular weight emulsifiers. By a low molecular weight emulsifier is meant an emulsifier with a molecular weight below 1500 g/mol. For example, the creamer composition may not comprise an emulsifier selected from the group consisting monoglycerides, diglycerides, acetylated monoglycerides, sorbitan trioleate, glycerol dioleate, sorbitan tristearate, propyleneglycol monostearate, glycerol monooleate and monostearate, sorbitan monooleate, propylene glycol monolaurate, sorbitan monostearate, sodium stearoyl lactylate, calcium stearoyl lactylate, glycerol sorbitan monopalmitate, diacetylated tartaric acid esters of monoglycerides, succinic acid esters of mono- and/or diglycerides, lactic acid esters of mono- and/or diglycerides, and sucrose esters of fatty acids, and combinations thereof.

In some embodiments, the creamer composition comprises pectin (e.g. sugar beet pectin), an oil component (e.g. vegetable oil) and a bulking agent and is substantially devoid of any additional agents.

In some embodiments, the creamer composition comprises pectin (e.g. sugar beet pectin), an oil component (e.g. vegetable oil), a bulking agent, and a pH control agent (e.g. base) and is substantially devoid of any other additional agents.

In some embodiments, the creamer composition comprises pectin (e.g. sugar beet pectin), an oil component (e.g. vegetable oil), a bulking agent, and a foaming agent (e.g. plant protein) and is substantially devoid of any other additional agents.

In some embodiments, the creamer composition comprises pectin (e.g. sugar beet pectin), an oil component (e.g. vegetable oil), a bulking agent, a pH control agent (e.g. base), and a foaming agent (e.g. plant protein) and is substantially devoid of any other additional agents.

By “substantially devoid” is meant that no additional agents are added as such to the composition, and that any additional agents present originate from minor traces or impurities present in the other components.

Beverages, Capsules, and Systems

Beverage Composition

The present invention provides a beverage composition comprising the creamer composition described herein. The beverage may be any suitable beverage such as a coffee, tea, or cocoa beverage. The beverage composition may be a ready-to-drink beverage or a ready-to-use beverage.

The present invention further provides a powdered coffee, tea, or cocoa beverage composition comprising soluble coffee, tea, or cocoa and a powdered creamer composition according to the invention. By a powdered coffee, tea, or cocoa beverage composition is meant a powdered composition suitable for providing a coffee, tea, or cocoa beverage by dissolution in a liquid, preferably water, such as instant coffee, instant tea, or instant cocoa. Powdered coffee, tea, or cocoa beverage compositions comprising soluble coffee, tea, or cocoa in combination with powdered creamer are well known in the art. Powdered coffee, tea, or cocoa beverages may further comprise sweeteners, e.g. sugar, and flavours. In a preferred embodiment, the invention relates to a powdered coffee beverage comprising soluble coffee and a powdered creamer composition according to the invention. In another preferred embodiment, the invention relates to a powdered tea beverage comprising soluble tea and a powdered creamer composition according to the invention.

The present invention further provides a method of preparing a beverage composition, comprising: (i) providing a beverage composition base; and (ii) adding the creamer composition described herein to the beverage composition base.

The beverage composition base may be any suitable beverage such as a coffee, tea, or cocoa beverage. The creamer composition may be added in powder or liquid form to the beverage composition base. The creamer composition may impart specific characteristics such as colour (e.g. whitening effect), thickening, flavour, texture, and/or other desired characteristics, for example as a substitute for milk or cream as an additive to the beverage composition.

Beverage Capsule

The present invention provides a beverage capsule comprising the creamer composition described herein. The beverage capsule may comprise the powdered creamer composition of the invention.

Beverage capsules are well known in the art and any suitable capsule may be used. In the scope of the present invention, the term capsule includes small flexible and/or rigid containers for example pouches. Suitable capsules are e.g. disclosed in WO03059778 and EP 0512468. The construction of the capsule will depend on the particular beverage machine(s) for which is intended to be used. Several such beverage machines adapted to the preparation of beverages from capsules exists and are well known in the art. The beverage capsule comprises a chamber wherein the powdered creamer composition of the invention is present. The chamber may be hermetically sealed or it may be partly open to the environment. Beverage capsules are constructed such that water, or another suitable liquid, can be injected into the chamber where the powdered creamer composition of the invention is present so that the powdered creamer composition is dissolved when a beverage is prepared from the capsule in a beverage preparation apparatus. The liquid with dissolved creamer is led from the capsule into a cup or other suitable container.

Beverage System

The present invention provides a beverage system comprising the creamer composition described herein. The beverage system may comprise the powdered creamer composition of the invention.

Beverage systems are well known in the art and widely available commercially. Any suitable beverage system may be used. Beverage systems include beverage preparation machines, automated systems for dispensing beverages (e.g. beverage vending machines), and the like. Beverage preparation systems for portioned beverage are well known in the art. They usually comprise a machine into which one or more ingredient containers (e.g. beverage capsule) are inserted. The machine is able to pass a fluid, typically hot water through an ingredient contained in the container, so as to produce a beverage.

Method of Manufacture

The present invention provides a process for producing a creamer composition comprising the steps of:
(i) providing an aqueous phase comprising sugar beet pectin, an oil phase comprising vegetable oil, and a bulking agent;
(ii) mixing the aqueous phase, the oil phase, and the bulking agent to form a pre-emulsion;
(iii) homogenising the pre-emulsion to form an emulsion concentrate; and
(iv) optionally drying the emulsion concentrate to form a powdered creamer composition.

In step (i) of the method an aqueous solution is prepared. Water soluble ingredients, e.g. pectin, plant protein, base, may be added to the aqueous solution at this stage. The aqueous phase may mixed under high agitation for e.g., 10-15 minutes and/or may be heated e.g. to 70° C., to ensure complete dissolution of the ingredients, e.g. pectin.

In step (i) of the method an oil phase is also prepared comprising the oil component and oil soluble ingredients. The oil phase may be mixed and heated, e.g. to 60-70° C.

In step (ii) of the method the aqueous phase, the oil phase, and the bulking agent are mixed. The oil phase and bulking agent may be incorporated into the aqueous phase under high agitation for e.g., 5 minutes and/or may be heated, e.g. to 60-70° C. In some embodiments, the aqueous phase and oil phase are mixed prior to the adding the buking agent. In some embodiments, the aqueous phase and the bulking agent are mixed prior to adding the oil phase.

In step (iii) the pre-emulsion is homogenised. The term “homogenising” or “homogenised” or homogenisation” is a unit operation using a class of processing equipment referred to as homogenisers that are geared towards reducing the size of droplets in liquid-liquid dispersions. Examples of homogenisers may include high speed blender, high pressure homogenisers, Colloid Mill, high shear dispersers, ultrasonic disruptor, membrane homogenisers. Homogenisation may take place at, for example, 180/50 bar or 250/50 bar.

Heat Treatment Step

In some embodiments, the method further comprises a heat treatment step. The heat treatment step may be performed before or after homogenisation. The heat treatment step may be a step of pasteurizing or commercially sterilizing the pre-emulsion or emulsion concentrate.

Suitable heat treatment steps are well known in the art. A pasteurizing step may be performed at a minimum temperature of 81° C. for at least 5 seconds. The composition as obtained after the pasteurizing step can be used for making ready-to-drink beverages.

The method may comprise steps of HTST (high temperature short time) or UHT (Ultra-high temperature processing) using either direct or indirect process; and filled on a clean fill, ultra clean fill (ESL) or aseptic filler.

Foaming or Gassing Step

In some embodiments, the method further comprises a foaming step and/or a gassing step. In particular, when the creamer composition is a foaming creamer the method may comprise such a step.

Suitable foaming steps and gassing steps are well known in the art. For example, the steps may comprise gassing the pre-emulsion or the emulsion concentrate e.g. at 4.0 NL/min.

Drying Step

In some embodiments, the method further comprises a drying step (step (iv)). In particular, when the creamer composition is a powdered creamer the method may comprise such a step.

Suitable drying steps are well known in the art. The drying step may be performed by spray drying, vacuum band drying, roller drying or freeze drying. In some embodiments, the drying step is performed by spray drying. Suitable spray drying conditions are well known in the art.

The powdered creamer obtained after the drying step can be used for making powdered creamers for use in beverage industry for example as milk additive for beverages (e.g. coffee, tea, cocoa) or for culinary applications (e.g. soups, sauces). Such a powdered creamer may also be used for preparation of capsules to be used in a beverage dispenser or may also be used for a beverage system.

Cooling and Packing Steps

In some embodiments, the method further comprises a step of cooling and/or packing the creamer composition.

Suitable cooling and/or packing steps are well known in the art. For example, an after-dryer after-cooler step may be used to cool the creamer composition, and filling and closing steps may be used to pack the creamer composition.

### EXAMPLES

The invention will now be further described by way of examples, which are meant to serve to assist one of ordinary skill in the art in carrying out the invention and are not intended in any way to limit the scope of the invention.

### Example 1—Sugar Beet Pectin Emulsified Creamers

The pectin used is a commercially available sugar beet pectin, GENU BETA Pectin from CPKelco. It is a high ester pectin derived from sugar beet pulp proposed for fruit flavoured drinks. The manufacturer specification is shown in Table 1.

TABLE 1
Specification of GENU BETA Pectin from CPKelco

| | |
|---|---|
| Typical application | 1-3% |
| Degree of esterification | ~55% |
| Degree of acetylation | 14-26% |
| pH (in 1% solution) | 3-4 |
| Molecular weight | >60000 Da |

An oil in water emulsion was prepared with a 12% solution of non-hydrogenated coconut oil. The ratio of pectin to fat was roughly 1:20 (wt/wt). The pectin was diluted in the water and mixed for 20 minutes at 70° C. Oil was added and the concentrate was reduced to a temperature of 60° C. and mixed for a further 10 minutes. Glucose syrup was added and mixed for a further 10 minutes before the concentrate was premixed with a hand held mixer at medium shear for 2 minutes, before being homogenized at approximately 250/50 bar. The mass trial recipe is shown in Table 2.

TABLE 2
Mass of ingredients in trial recipe

| | Glucose syrup | Coconut | Sugar Beet | Water |
|---|---|---|---|---|
| | DE 28-32% (%) | oil (%) | Pectin (%) | (%) |
| Concentrate | 60.4 | 12.2 | 0.6 | 26.8 |
| (60% TS) | | | | |
| Powder | 76.8 | 20.0 | 1.0 | 3.0 |

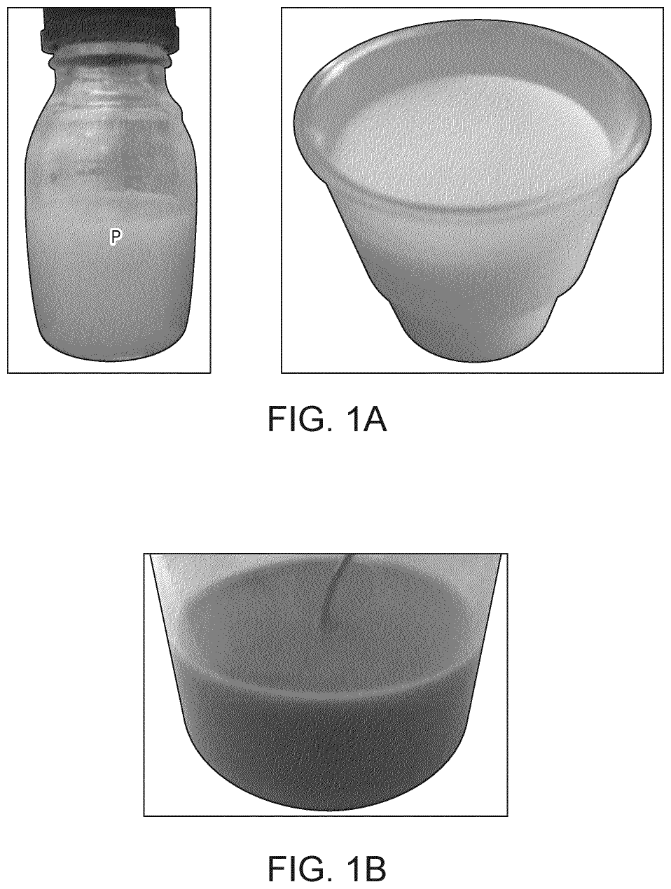

After homogenization, the emulsion was light white with low viscosity. When the concentrate was diluted in water (i.e. lower TS) for PSD measurements, there was greater light scattering and a bright white colour was obtained (see FIG. 1B).

10-15 ml of concentrate was added to 200 ml of RVRF coffee to check for feathering/fat eyes/etc. The beverage was extremely stable over time (2-3 hours). No fat was visible on the surface and no aggregation, creaming or sedimentation was apparent (see FIG. 1A).

The sample was also tasted. No foreign flavours were apparently detectable and the taste was quite neutral, as opposed to the legume taste often associated with plant proteins.

The pH of the concentrate was measured at ambient temperature. Approximately 10-15 ml was also added to 200 ml of coffee (1.7 g RVRF 150). The pH is shown in Table 3.

TABLE 3
Recorded pH of trialled creamer

| Sample | pH |
|---|---|
| Emulsion concentrate | 4.3 |
| Coffee | 5.2 |

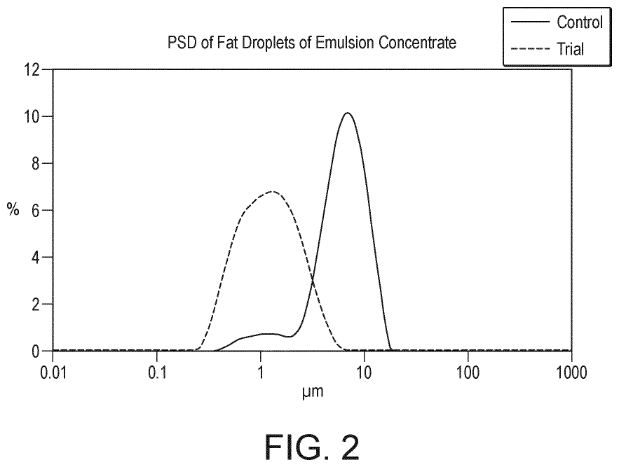

Particle size distribution was measured immediately after homogenization. As a comparison, the PSD of a rice protein-lecithin creamer is used as a control for comparison. The difference is quite large with a much lower d(4,3) of ˜1.3 um compared to 9.6 um (see FIG. 2).

The trial was repeated to check for viscosity and rheological behaviour. A small change in recipe was the use of reconstituted dehydrated glucose syrup in place of the concentrate.

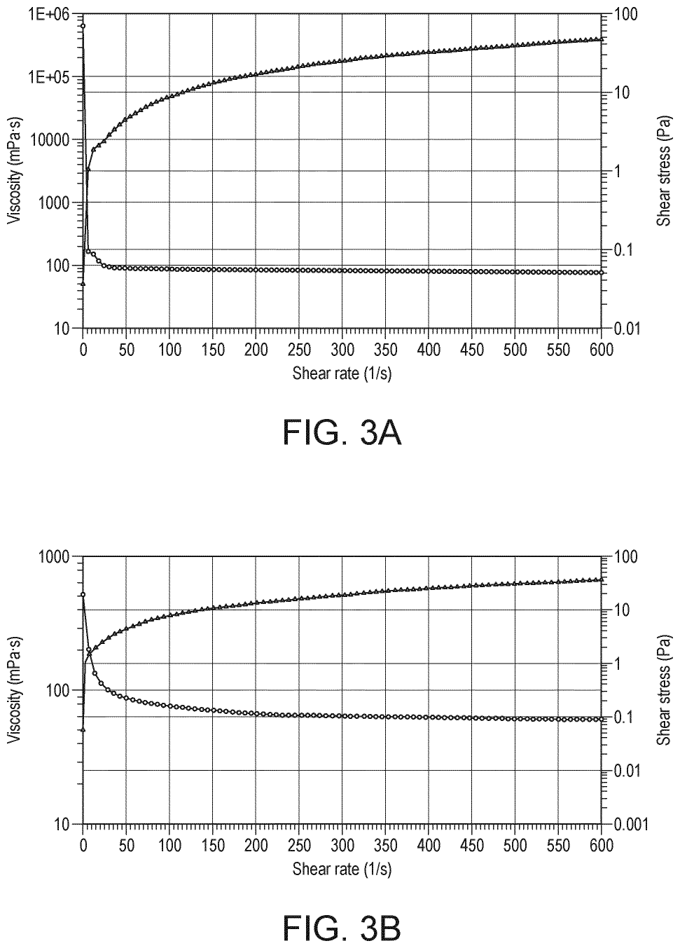

A shear rate of 0-600 s⁻¹ was run on a viscometer at a temperature of 75° C. The viscosity was quite constant from 50-600 s⁻¹ at 90 mPa (see FIG. 3A).

As a comparison, a rice protein-lecithin creamer is shown which exhibits greater shear thinning between 0-300 s⁻¹, but remains at quite a steady 60 mPa between 300-600 s⁻¹ (see FIG. 3B). TS of this sample was ˜62%.

Sugar beet pectin as a sole emulsifier created a stable emulsion on a 12% o/w emulsion at a ratio of 1:20 pectin to fat. PSD results showed the emulsion to have small droplet diameter with a d(4,3) of 1.3 um. Whitening and stability were adequate when emulsion concentrate was added to coffee. No issues were noticeable with the viscosity of the concentrate. The flavour of the creamer was more neutral than creamers from plant based proteins.

### Example 2—Pilot Plant Development: Sugar Beet Pectin Emulsified Creamers

Following on from development in the laboratory, the recipe was scaled up for production.

Trials 29805.070 and 074

The first trials were a scale up of the laboratory recipe (20% fat content) and created the following powder composition (Table 4):

TABLE 4
Composition for trials 29805.070 and 074

| Ingredient | Composition % |
|---|---|
| Glucose syrup DE 28-32 | 76 |
| Non-hydrogenated Coconut oil | 20 |
| Sugar Beet Pectin | 1 |

50 kg of concentrate at 60% TS was prepared and spray dried. Two variants were produced—the major difference being the gassing—29805.070 (not gassed) and 29805.075 (gassed). The concentrate was spray dried with ease and the powder flowed without interruption or problem. The online and offline measurements were as following (Table 5):

TABLE 5
Powder and concentrate properties from trials 29805.070 and 074

| | 29805.070 | | 29805.075 | |
|---|---|---|---|---|
| Viscosity of concentrate (at 400 s⁻¹) | 133 | mP | 110 | mP |
| pH of concentrate | 3.62 | | 3.66 | |
| Dry matter of concentrate | 62% | | 62% | |
| Powder moisture | 3.24% | | 3.21% | |
| Free fat | 1.9% | | 2.5% | |
| d(0.5) of powder (dry) | 314 | um | 236 | um |
| Closed porosity | 6.9% | | 37.6% | |
| Density | 1.2 | g/cm³ | 0.9 | g/cm³ |
| True density | 1.37 | g/ml | 1.38 | g/ml |
| Tapped density | 320 | g/L | 240 | g/L |

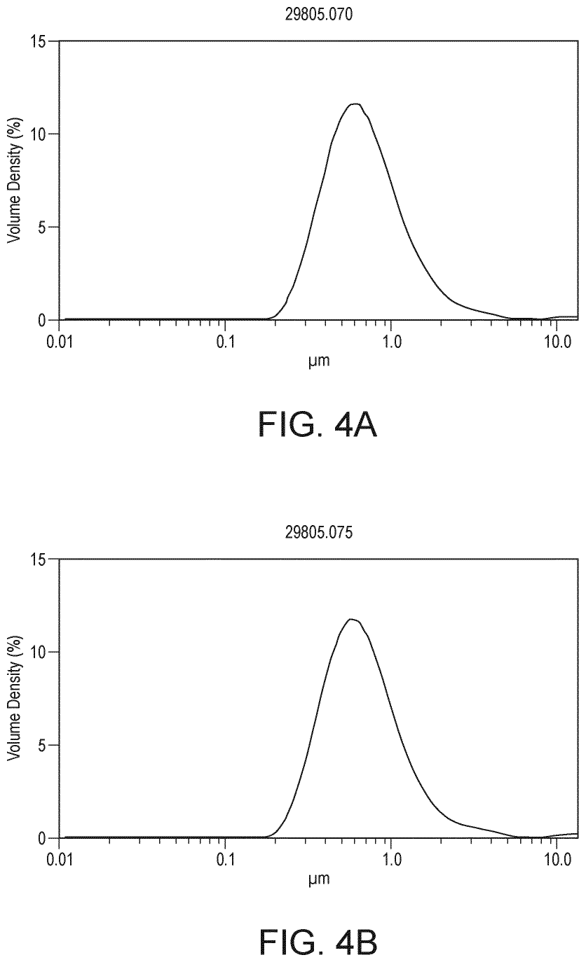

Powders achieved a low tapped density even without gassing. Free fat was low, which has been an issue with previous plant protein-stabilized powders. The emulsion concentrate appeared stable and the PSD showed similar small droplet size as the lab samples with a d(4,3) of 1.92 and 1.96 um respectively. The d(0.5) of the emulsions were 0.65 and 0.64 um, respectively (see FIG. 4).

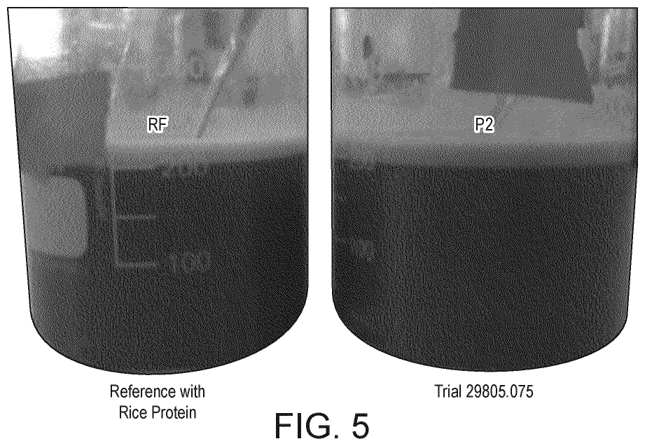

When reconstituted the powder gave good whitening and no sedimentation, flocculation, feathering, fat eyes, etc. was observed. The colour of the pectin variant was actually lighter than the reference (despite lower fat, and the addition of CaCO₃ and rice flour in the reference) (see FIG. 5).

The creamer when reconstituted in water has a clean, strong white appearance. The taste is quite neutral.

Trials 32049.014 and 32049.015

The second trials used an increase in fat content and the addition of calcium carbonate to further increase the whitening and mouthfeel from the creamer. Table 6 shows the composition of the powders. 500 kg of concentrate at 60% TS was prepared. Spray drying was again without incident.

TABLE 6
Composition for trials 32049.014 and 32049.015

| Ingredient (wt %) | 32049.014 | 32049.015 |
|---|---|---|
| Glucose syrup DE 28-32 | 71.9 | 68.9 |
| NHCO | 24 | 24 |
| Sugar Beet Pectin | 1.1 | 1.1 |
| Calcium carbonate | — | 3 |
| Rice flour | — | — |
| Water | 3 | 3 |

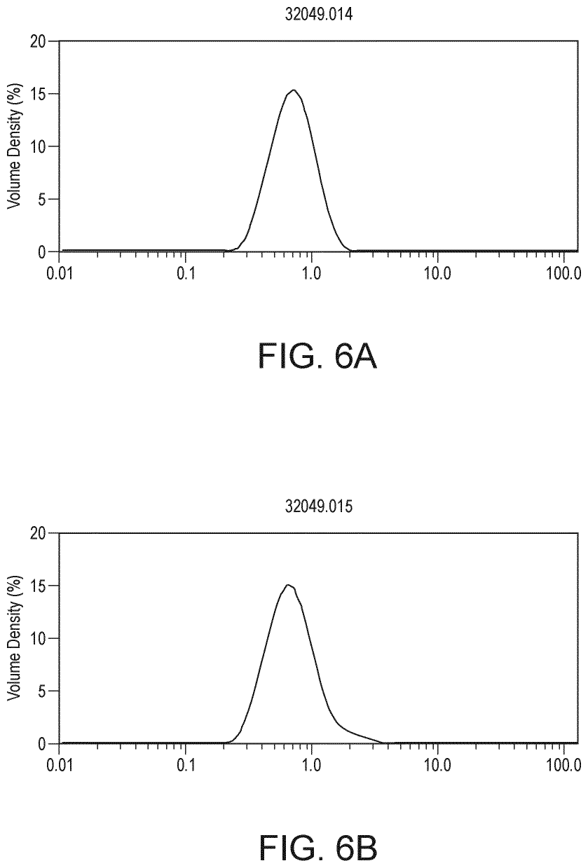

The measurements are recorded in Table 7 and PSD shown in FIG. 6.

TABLE 7
Powder and concentrate properties
from trials 32049.014 and 32049.015

| | |
|---|---|
| 32049.014 | 32049.015 |

| | | |
|---|---|---|
| pH of concentrate | 4.07 | 6.95 |
| Dry matter of concentrate | 62.4 | 63.4 |

| | | |
|---|---|---|
| Powder moisture | 3.4% | 3.3% |

| | | |
|---|---|---|
| Water Activity | 0.176 | 0.170 |

| | | |
|---|---|---|
| Free fat | 1% | 0.7% |

| | | | | |
|---|---|---|---|---|
| Tapped density | 514 | g/L | 532 | g/L |
| True density | 1.19 | g/ml | 1.19 | g/ml |
| D(0.5) of Powder | 407 | um | 567 | um |

| | | |
|---|---|---|
| Closed porosity | 0% | 0% |

Trial 32049.015 has a higher concentrate pH than trial 32049.014. The low pH is due to the hydronium ions, which derive from the sugar beet pectin. Interactions with calcium carbonate induce a shift towards a neutral pH. The change of pH seems to have no effect on the emulsion stability.

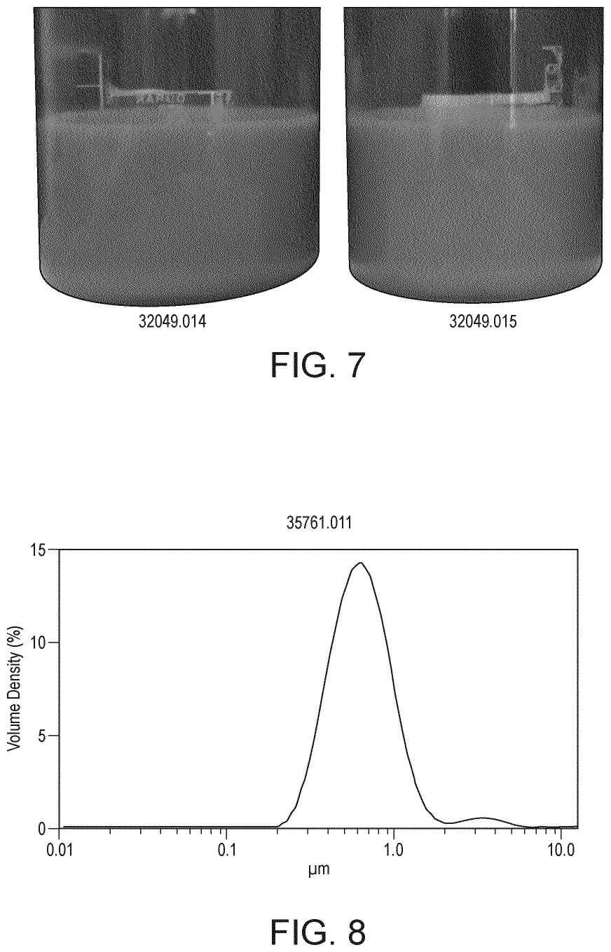

Both powders showed good reconstitution and good whitening. Trial 32049.015 appeared lighter in colour than 32049.014 (see FIG. 7).

The addition of calcium carbonate was noted to bring greater whiteness and mouthfeel to the beverage. Sample 32049.015 had a more rounded mouthfeel.

Trial 35761.011

To investigate the potential use as a cold soluble vegan creamer, a trial was conducted using sugar beet pectin alongside an MCT oil (low melting point). The fat content was also increased to 24% to further increase mouthfeel.

The trial created a powder with the following powder composition (Table 8). 50 kg of concentrate at 60% TS was prepared and spray dried.

TABLE 8
Composition for trial 35761.011

| Ingredient | Composition % |
|---|---|
| Glucose syrup DE 28-32 | 71.85 |
| Medium chain triglycerides | 24.0 |
| Sugar Beet Pectin | 1.15 |
| Water | 3.0 |

The concentrate was, again, spray dried with ease and the powder flowed without interruption or problem. The online and offline measurements were as following (Table 9):

TABLE 9
Powder and concentrate properties from trial 35761.011

| | 35761.011 |
|---|---|
| pH of concentrate | 3.67 |
| Dry matter of concentrate | 61.2% |
| Powder moisture | 3.43% |
| Free fat | 2.2% |
| Tapped density | 396 |

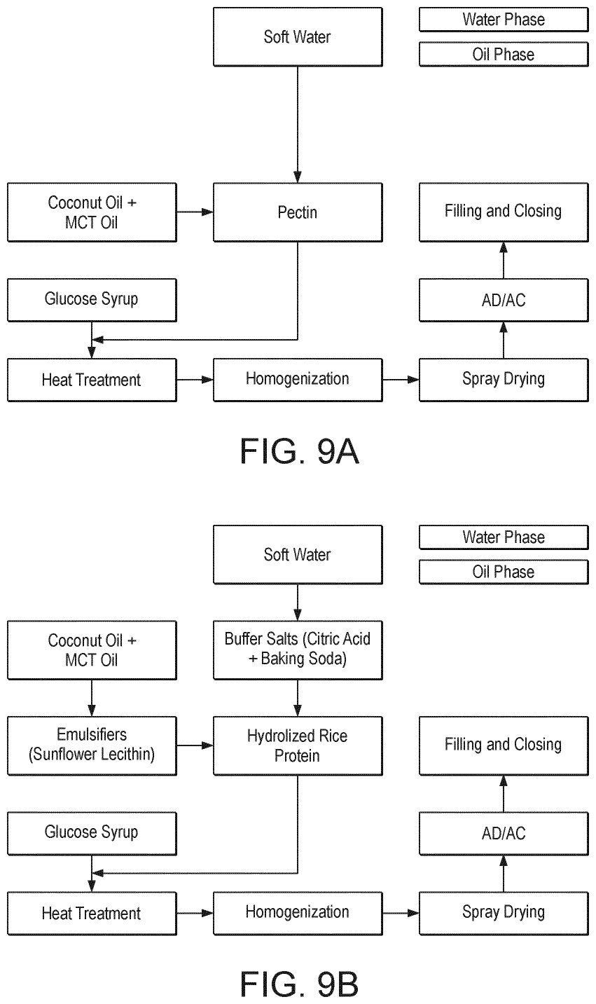

As previously, the emulsion concentrate contained a close to optimal particle size distribution of fat droplets, with a d(4,3) of 0.990 um and a d(0,5) of 0.632 um (see FIG. 8).

### Example 3—Comparison Between Sugar Beet Pectin and Hydrolysed Rice Protein as Emulsifiers in Powder Creamers

Two trials were performed to give a direct comparison of a formulation with hydrolysed rice protein and lecithin as emulsifier/co-emulsifier against a formulation with sugar beet pectin as the sole emulsifier. Table 10 presents the recipe composition for the trials, both with a total fat content of 35%.

TABLE 10
Composition for trials 37964.005 (sugar beet pectin)
and 37964.006 (hydrolysed rice protein).

| Ingredient (wt %) | 37964.005 | 37964.006 |
|---|---|---|
| Glucose syrup | 60.70 | 56.20 |
| Coconut oil (non-hydrogenated) | 30.00 | 30.00 |
| MCT oil | 5.00 | 5.00 |
| Sunflower lecithin powder | 0.00 | 0.60 |
| Hydrolysed rice protein | 0.00 | 3.00 |
| Citric acid | 0.00 | 0.70 |
| Baking soda | 0.00 | 1.50 |
| Sugar beet pectin | 1.30 | 0.00 |
| Water | 3.00 | 3.00 |

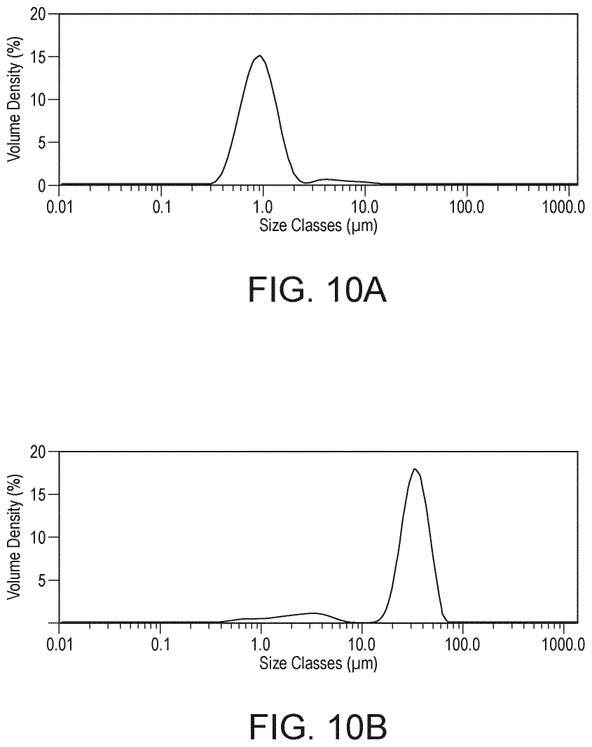

FIG. 9 shows the simplified process flow chart for the creamer bases. The concentrate, powder and beverage properties of the trials are shown below in Table 11:

TABLE 11
Powder and concentrate properties
from trials 37964.005 and 37964.006

| | | 37964.005 | 37964.006 |
|---|---|---|---|
| Concentrate | Total solids (%) | 61.60 | 60.00 |
| | Viscosity at nozzle (mPa · s) | 113 | 15.9 |
| | Flat globule size | 0.55 | 4.47 |
| | (d10, microns) | | |
| | Flat globule size | 0.91 | 32.00 |
| | (d50, microns) | | |
| | Flat globule size | 1.57 | 47.20 |
| | (d90, microns) | | |
| Powder | Total fat (%) | 34.5 | 34.3 |
| | Total water (%) | 2.96 | 3.14 |
| | Free fat (%) | 2.9 | 6.3 |
| | Water activity (—) | 0.169 | 0.198 |
| | Tap density (g/l) | 460 | 490 |
| Reconstitution* | Flocculation | Absent | Absent |
| | Fat eyes | Very small | Absent |
| | Sediment | Absent | Absent |

*8.1 g of creamer in 150 ml Folgers at 85° C. (prepared with 1.5 liters of water at 450 ppm and 40 g of Folgers Colombian Roast R&G).

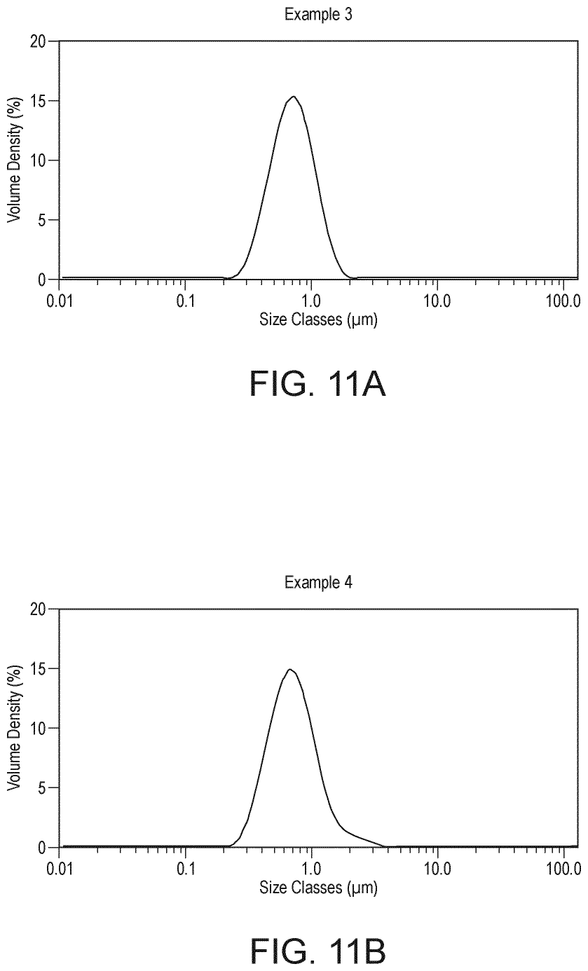

For trial 37964.005 (sugar beet pectin), the emulsion prior to spray drying was highly stable with a median particle size of 1.1 micron (see FIG. 10A). Sensorial attributes of the reconstituted powder were clean, despite the slight acidity of the beverage. In contrast, for trial 37964.006 (hydrolysed rice protein) the result was a poorly stabilized emulsion as shown in FIG. 10B, which caused heavy fouling during spray drying. This shows that the emulsion quality is much better (much smaller sizes) for the sugar beet pectin trial at comparable homogenization conditions (180/50 bar) and fat content (35%).

Further, trial 37964.005 (sugar beet pectin) was much more viscous at comparable temperature and TS compared to trial 37964.006 (hydrolysed rice protein).

Sensory evaluation was carried out using 5.4 gr of Creamer in 100 ml of black coffee prepared with 1.5 l of Vittel water and 40 gr of Folgers Classic Roast R&G in Mr. Coffee Machine.

Sample 37964.005 (sugar beet pectin) was found much whiter than sample 37964.006 (hydrolysed rice protein), likely to the better emulsion. Mouthfeel of both samples was acceptable.

Sample 37964.005 was found to be improved in acidity and providing rounder profile when adding baking soda in dry mix at 0.1%. That also improved the mouthfeel making it even thicker than 37964.006 in texture.

### Example 4—Exemplary Creamer Compositions

### Example 4-1: Vegan Powdered Coffee Creamer Stabilized with Sugar Beet Pectin

Pectin Hydration: 4 kg of Sugar Beet Pectin is added to 134 Kg of reverse osmosis water under continuous agitation at 60-70° C. for 10-15 min.
Vegetable fat: 92.8 Kg of Coconut oil and 15.4 of Medium Chain Triglycerides oil heated up to 60-70° C.
Filler: Addition of 250.5 kg of Glucose Syrup is combined with previous streams and agitated for 5 min.
Liquid feed sent to Heat treatment, Homogenization, Spray Drying, After-Dryer After-Cooler, Filling and packing (as depicted in FIG. 9A).

### Example 4-2: Vegan Powdered Creamer Stabilized with Rice Protein and Sunflower Lecithin

6.7 kg of buffer salts are added to 142 kg reverse osmosis water. 9.3 kg of rice proteins is mixed in with high shear before addition of 231.7 kg of glucose syrup.

Meanwhile 92.8 kg of coconut oil mixed with 15.5 kg of MCT is melted and to this 1.9 kg of sunflower lecithin. This oil-lecithin mix is subsequently added to the sugar-protein mix and prepared as shown in FIG. 9B.

### Example 4-3: Powdered Vegan Creamer

3.4 kg of sugar beet pectin was hydrated in 125.9 kg of reverse osmosis water. This was subsequently mixed with 296.3 kg of glucose syrup and 74.4 kg of coconut oil was finally added.

The powdered creamer was subsequently prepared using the same process described in example 4-1.

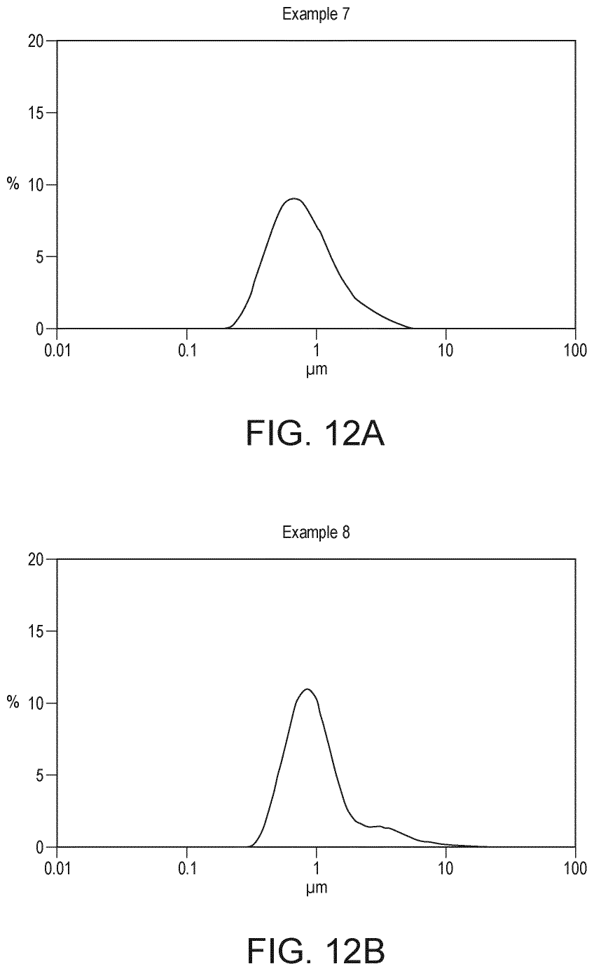

The reconstituted powder exhibited a median particle size of 0.7 micron (see FIG. 11A), and gave excellent whitening.

### Example 4-4: Powdered Vegan Creamer with Carbonate Adjusted pH

A powdered creamer was prepared as in example 4-3, with the addition of 9.5 kg of calcium carbonate. Subsequently, the emulsion was measured to arrive at pH 7 prior to spray drying.

As a result, a trained tasting panel found the product to give less astringency and greater mouth coating once reconstituted, in comparison to example 4-3. Measured particle size of the reconstituted powder was identical to example 4-3 (see FIG. 11B).

### Example 4-5: Liquid Creamer with Bicarbonate Adjusted pH

A liquid creamer was prepared 0.4 kg of sugar beet pectin hydrated in 15.4 kg of reverse osmosis water. Added to the mix was 34.6 kg of glucose syrup and 8.9 kg of coconut oil. Finally, 0.1 kg of soda bicarbonate was mixed into the concentrate, which took the pH from 3.3 to 6.6. Processing steps were as described in FIG. 9A, but without the drying stages (terminating after homogenization).

The liquid creamer gave good whitening and mouthfeel. Emulsion was stable over time with a median emulsion droplet size of 1.2 micron.

### Example 4-6: Liquid Creamer with Low Sugar Beet Pectin Concentration

A liquid creamer was prepared as described in example 4-5, with 0.04 kg of sugar beet pectin, 36 kg of glucose syrup and 8.9 kg of coconut oil.

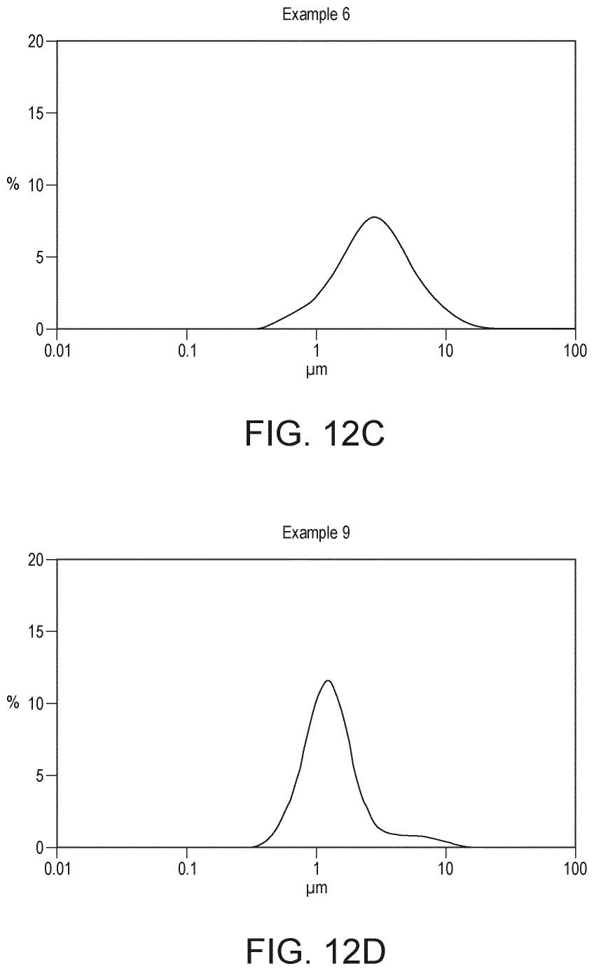

Stability was lower than examples 4-1 to 4-4 and the emulsion droplet size was measured at 3.8 micron (see FIG. 12C).

### Example 4-7: Liquid Creamer with Low Fat Concentration

A liquid creamer was prepared as described in example 4-5, with 0.15 kg of sugar beet pectin, 42.8 kg of glucose syrup and 3.7 kg of coconut oil. Whitening was lower example 4-5. Emulsion droplet size was ˜1 micron or less (see FIG. 12A).

### Example 4-8: Liquid Creamer with High Fat Concentration

A liquid creamer was prepared as described in example 4-5, with 0.75 kg of sugar beet pectin, 24.7 kg of glucose syrup and 16.7 kg of coconut oil.

Emulsion stability was excellent. Whitening increased compared to previous examples. Emulsion droplet size was ˜1 micron (see FIG. 12B).

### Example 4-9: Liquid Foaming Creamer with Added Plant Proteins

Liquid creamers were prepared as described in example 4-5, with the exception of sodium hydroxide. After homogenization, emulsions were enriched with plant protein, namely (i) 0.75 kg of faba bean protein isolate (ii) pea protein isolate (iii) hydrolyzed rice protein. The three concentrates were allowed to hydrate for 15 minutes.

Emulsion droplet size was ˜1 micron (see FIG. 12D).

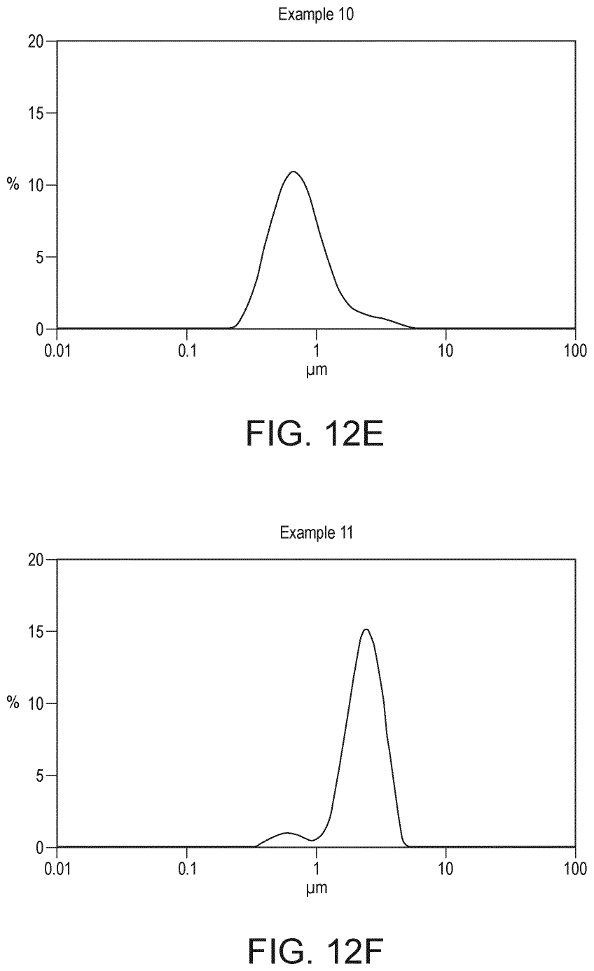

Foam was then prepared for the three emulsions by foaming in a Nespresso Cappuccinatore. Calculated foam overrun is shown in FIG. 13. No protein flocculation was observed despite the low pH of the emulsions.

### Example 4-10: Liquid Foaming Creamer with Adjusted pH and Added Plant Protein

Liquid creamers were prepared as described in example 4-5. Variants with plant proteins were then added as described in example 4-9.

Emulsion droplet size was ˜1 micron (see FIG. 12E).

Foam was then prepared for the three emulsions by foaming in a Nespresso Cappuccinatore. Calculated foam overrun is shown in FIG. 13.

### Example 4-11: Liquid Creamer Using Citrus Peel Pectin

Liquid creamer was prepared as described in example 4-5, without the addition of sodium hydroxide and substituting citrus peel pectin for the sugar beet pectin. Emulsion stability was low and sedimentation was observed in the storage tank, with a highly viscous liquid phase at the bottom of the tank. Emulsion droplet size was higher than other examples (see FIG. 12F).

### EMBODIMENTS

Various preferred features and embodiments of the present invention will now be described with reference to the following numbered paragraphs (paras).

1. A creamer composition comprising sugar beet pectin, vegetable oil and a bulking agent.

2. The creamer composition according to para 1, wherein the composition is in the form of a powdered creamer or a liquid creamer, preferably a powdered creamer.

3. The creamer composition according to para 1 or para 2, wherein the pectin is a high ester pectin, optionally wherein the pectin has a degree of esterification (DE) of at least about 50%, or at least about 55%, or from about 50% to about 60%, or about 55%.

4. The creamer composition according to any preceding para, wherein the pectin has a degree of acetylation (DAc) of at least about 10%, or at least about 15%, or at least about 20%, optionally wherein the pectin has a DAc of from about 10% to about 30%, or from about 14% to about 26%, or from about 20% to about 25%.

5. The creamer composition according to any preceding para, wherein the creamer composition comprises the pectin in an amount of from about 0.1 wt % to about 2.5 wt %, from about 0.3 wt % to about 1.5 wt %, or from about 0.7 wt % to about 1 wt %.

6. The creamer composition according to any preceding para, wherein the pectin and the oil are present in a pectin:oil weight ratio of from about 1:500 to about 1:4, or from about 1:250 to about 1:10, or from about 1:100 to about 1:20, or from about 1:25 to about 1:20.

7. The creamer composition according to any preceding para, wherein the pH of the creamer composition is at least about pH 3, at least about pH 4, at least about pH 5, at least about pH 6, or at least about pH 6.5, or from about pH 6.5 to about pH 8.

8. The creamer composition according to any preceding para, wherein the creamer composition further comprises a base.

9. The creamer composition according to para 8, wherein the base comprises or consists of one or more of: a carbonate salt, a bicarbonate salt (a hydrogen carbonate salt), or a hydroxide salt, or a solution thereof.

10. The creamer composition according to para 8 or para 9, wherein the base comprises or consists of one or more of: calcium carbonate, ammonium carbonate, magnesium carbonate, potassium carbonate, sodium carbonate, ammonium hydrogen carbonate, magnesium hydroxide carbonate, potassium hydrogen carbonate, sodium hydrogen carbonate, sodium sesquicarbonate, ammonium hydroxide, calcium hydroxide, magnesium hydroxide, potassium hydroxide, and sodium hydroxide, or a solution thereof.

11. The creamer composition according to any one of paras 8-10, wherein the base comprises of consists of sodium hydrogen carbonate or calcium carbonate, or a solution thereof.

12. The creamer composition according to any preceding para, wherein the creamer composition comprises the oil in an amount of from about 10 wt % to about 50 wt %, from about 25 wt % to about 50 wt %, or from about 35 wt % to about 50 wt %.

13. The creamer composition according to any preceding para, wherein the oil comprises or consists of one or more of: coconut oil, soy bean oil, rapeseed oil, sunflower oil, canola oil, safflower oil, palm oil, palm kernel oil, algal oil, cotton seed oil, or corn oil, and olive oil.

14. The creamer composition according to any preceding para, wherein the oil comprises or consists of non-hydrogenated vegetable oil, hydrogenated vegetable oil, interesterified vegetable oil, and/or medium-chain triglyceride (MCT) vegetable oil.

15. The creamer composition according to any preceding para, wherein the oil comprises or consists of coconut oil, hydrogenated coconut oil and/or MCT oil, preferably wherein the MCT oil is derived from coconut and/or palm kernel oil.

16. The creamer composition according to any preceding para, wherein the creamer composition comprises the bulking agent in an amount of from about 10 wt % to about 80 wt %.

17. The creamer composition according to any preceding para, wherein the bulking agent comprises or consists of one or more of: syrups; soluble/insoluble fibers, preferably derived from corn, wheat, pea, rice, oat, coconut, barley and/or tapioca; fructo- and galacto-oligosaccharides; and hydrolysed cereal flour.

18. The creamer composition according to any preceding para, wherein the bulking agent comprises or consists of one or more of: glucose syrup, powdered glucose, starch, corn syrup solids, maltodextrin, and dextrin.

19. The creamer composition according to any preceding para, wherein the creamer composition comprises:
the pectin in an amount of from about 0.1 wt % to about 2.5 wt %;
the oil in an amount of from about 10 wt % to about 50 wt %; and
the bulking agent in an amount of from about 10 wt % to about 80 wt %.

20. The creamer composition according to any preceding para, wherein the creamer composition is a foaming creamer.

21. The creamer composition according to any preceding para, wherein the creamer composition further comprises a foaming aid.

22. The creamer composition according to para 21, wherein the foaming aid comprises or consists of one or more of: plant protein (e.g. plant protein isolate and/or hydrolysed plant protein), optionally wherein the plant protein is selected from one or more of faba bean protein, pea protein, rice protein, oat protein, soy protein; polysaccharide; and saponin, optionally wherein the saponin is derived from quillaja.

23. The creamer composition according to any preceding para, wherein the creamer composition is substantially devoid of buffering agent and/or stabilising agent.

24. The creamer composition according to any preceding para, wherein the only emulsifier in the creamer composition is the pectin.

25. The creamer composition according to any preceding para, wherein the creamer composition is a vegan creamer.

26. The creamer composition according to any preceding para, wherein the creamer composition is a beverage creamer, preferably a coffee creamer, a tea creamer or a cocoa creamer.

27. A beverage capsule comprising the creamer composition according to any one of paras 1-26.

28. A beverage system comprising the creamer composition according to any one of paras 1-26.

29. A beverage composition comprising the creamer composition according to any one of paras 1-26, optionally wherein the beverage composition is a coffee, tea, or cocoa beverage.

30. Use of sugar beet pectin as an emulsifier in a creamer composition, preferably a beverage creamer composition, such as a coffee creamer, a tea creamer or a cocoa creamer.

31. A method for producing the creamer composition according to any one of paras 1-26, comprising:
(i) providing an aqueous phase comprising sugar beet pectin, an oil phase comprising vegetable oil, and a bulking agent;
(ii) mixing the aqueous phase, the oil phase, and the bulking agent to form a pre-emulsion;
(iii) homogenising the pre-emulsion to form an emulsion concentrate;
(iv) optionally drying the emulsion concentrate to form a powdered creamer composition.

32. The method according to para 31, wherein the aqueous phase and oil phase are mixed prior to the adding the buking agent.

33. The method according to para 31 or para 32, wherein the method further comprises a heat treatment step.

34. The method according to any one of paras 31-34, wherein the method further comprises a foaming step.

35. The method according to any one of paras 31-34, wherein the method further comprises a step of cooling the creamer composition and/or a further step of packing the creamer composition.

36. The method according to any one of paras 31-35, wherein the drying is spray drying.

37. A method of preparing a beverage composition, comprising:
(i) providing a beverage composition base; and
(ii) adding the creamer composition according to any one of paras 1-26 to the beverage composition base.

All publications mentioned in the above specification are herein incorporated by reference. Various modifications and variations of the disclosed methods, compositions and uses of the invention will be apparent to the skilled person without departing from the scope and spirit of the invention. Although the invention has been disclosed in connection with specific preferred embodiments, it should be understood that the invention as claimed should not be unduly limited to such specific embodiments. Indeed, various modifications of the disclosed modes for carrying out the invention, which are obvious to the skilled person are intended to be within the scope of the following claims.

1. A creamer composition comprising sugar beet pectin, vegetable oil and a bulking agent.

2. The creamer composition according to claim 1, wherein the composition is in the form of a powdered creamer.

3. The creamer composition according to claim 1, wherein the creamer composition comprises the pectin in an amount of from about 0.1 wt % to about 2.5 wt %, from about 0.3 wt % to about 1.5 wt %, or from about 0.7 wt % to about 1 wt %.

4. The creamer composition according to claim 1, wherein the pectin and the oil are present in a pectin:oil weight ratio of from about 1:500 to about 1:4, or from about 1:250 to about 1:10, or from about 1:100 to about 1:20, or from about 1:25 to about 1:20.

5. The creamer composition according to claim 1, wherein the pH of the creamer composition is at least about pH 5.

6. The creamer composition according to claim 1, wherein the creamer composition further comprises a base.

7. The creamer composition according to claim 1, wherein the creamer composition comprises the oil in an amount of from about 10 wt % to about 50 wt %, from about 25 wt % to about 50 wt %, or from about 35 wt % to about 50 wt %.

8. The creamer composition according to claim 1, wherein the oil is selected from the group consisting of: coconut oil, soy bean oil, rapeseed oil, sunflower oil, canola oil, safflower oil, palm oil, palm kernel oil, algal oil, cotton seed oil, or corn oil, and olive oil.

9. The creamer composition according to claim 1, wherein the creamer composition comprises the bulking agent in an amount of from about 10 wt % to about 80 wt %.

10. The creamer composition according to claim 1, wherein the creamer composition further comprises a foaming aid.

11. A beverage capsule comprising a creamer composition comprising sugar beet pectin, vegetable oil and a bulking agent.

12-14. (canceled)

15. A method for producing the creamer composition comprising:
(i) providing an aqueous phase comprising sugar beet pectin, an oil phase comprising vegetable oil, and bulking agent;
(ii) mixing the aqueous phase, the oil phase, and the bulking agent to form a pre-emulsion;
(iii) homogenising the pre-emulsion to form an emulsion concentrate; and
(iv) drying the emulsion concentrate to form a powdered creamer composition.
